(19) United States
(12) Patent Application Publication
(10) Pub. No.: US 2017/0163825 A1
(43) Pub. Date: Jun. 8, 2017

(54) MATRIX FACTORIZATION FOR USER PROFILING AND OUTLIER DETECTION IN ACTIVITY DATA

(71) Applicant: XEROX CORPORATION, NORWALK, CT (US)

(72) Inventors: Jean-Marc Andreoli, Meylan (FR); Yves Hoppenot, Notre-Dame-de-Mesage (FR)

(73) Assignee: XEROX CORPORATION, NORWALK, CT (US)

(21) Appl. No.: 14/961,232

(22) Filed: Dec. 7, 2015

(51) Int. Cl. H04N 1/00; G06F 3/12

(52) U.S. Cl. CPC H04N 1/00344; H04N 1/00015; H04N 1/00039; H04N 1/00055; G06F 3/1203; G06F 3/1259; G06F 3/1288; H04N 2201/0094

(57) ABSTRACT

A method for inferring user activity statistics includes receiving job logs of a device infrastructure. Each job log including job information for a job performed for one of a set of users by one of a plurality of shared devices. A job descriptor is generated for each job based on the job log. The job is assigned to one of a set of defined job types based on the job descriptor. An activity matrix is composed where activity of each user for each of a plurality of time periods is represented as a fixed-length vector representing at least some of the job types. Each index of the vector is derived from a count of one job type for the user in that time period. The activity matrix is decomposed into first and second factor matrices to minimize an overall reconstruction error. User activity statistics are output based on the decomposition.

### BACKGROUND

The exemplary embodiment relates to analysis of users' activity and finds particular application in connection with a system and method for analyzing print behavior based on print job jogs.

The costs of printing can be high both for the customer and for the environment. Accordingly, it would be helpful to understand users' printing behavior, could lead to reductions in the amount of unnecessary printing, particularly those print jobs which are not authorized by the customer. However, users of a printing infrastructure often vary in their use of printers from day to day, thus it is difficult to gain insights into their prototypical behavior.

Enterprises and organizations often outsource the management of their printing infrastructure. The outsourcing often covers the maintenance of the devices in the infrastructure, and relies on operation data from the devices, collected at the customer site(s). This allows collection of printing data from the customer. However, the customer may be unwilling to share all of the data collected, such as the textual content of print jobs, for confidentiality reasons.

A system and method are provided which facilitate activity profiling and outlier detection and which are able to exploit job data in a very generic form.

### INCORPORATION BY REFERENCE

The following references, the disclosures of which are incorporated herein by reference, are mentioned:

U.S. Pub. No. 20140180651, published Jun. 26, 2014, entitled USER PROFILING FOR ESTIMATING PRINTING PERFORMANCE, by Svetlana Lysak, et al.

U.S. Pub. No. 20140136451, published May 15, 2014, entitled DETERMINING PREFERENTIAL DEVICE BEHAVIOR, by Lukas M. Marti, et al.

U.S. Pub. No. 20070268509, published Nov. 22, 2007, entitled SOFT FAILURE DETECTION IN A NETWORK OF DEVICES, by Jean-Marc Andreoli, et al.

### BRIEF DESCRIPTION

In accordance with one aspect of the exemplary embodiment, a method for inferring user activity statistics from job logs of a device infrastructure includes receiving job logs of a device infrastructure. Each job log includes job information for a job performed for a respective one of a set of users by a respective one of a plurality of shared devices. A feature-based job descriptor is generated for each job based on the respective job log. Each job is assigned to one of a set of defined job types based on the feature-based job descriptor. A user activity matrix is composed in which activity of each user for each of a plurality of time periods is represented as a fixed-length vector representing at least some of the job types, each index of the vector being based on a count of a respective one of the assigned job types for the respective user in the respective time period. The user activity matrix is decomposed into first and second factor matrices to minimize an overall reconstruction error between the user activity matrix and a reconstructed matrix generated from the factor matrices. User activity statistics are output based on at least one of: the first factor matrix, the second factor matrix, and reconstruction errors between the user activity matrix and the reconstructed matrix.

At least one of the generating, assigning, composing, decomposing, and outputting may be performed with a processor.

In accordance with another aspect of the exemplary embodiment, system for inferring user activity statistics from job logs of a device infrastructure includes a descriptor generator which generates a feature-based job descriptor for each of a set of job logs. Each job log includes job information for a job performed for a respective one of a plurality of users by a respective one of a plurality of shared devices. An assignment component assigns each job to one of a set of defined job types based on the respective feature-based job descriptor. A matrix generator composes a user activity matrix in which activity of each user for each of a plurality of time periods is represented as a fixed-length vector representing at least some of the job types, each index of the vector being based on a count of a respective one of the assigned job types in the respective time period. A factorization component decomposes the user activity matrix into first and second factor matrices. The factorization minimizes an overall reconstruction error between the user activity matrix and a reconstructed matrix generated from the factor matrices. An output component outputs user activity statistics based on at least one of: the first factor matrix, the second factor matrix, and reconstruction errors between the user activity matrix and the reconstructed matrix. A processor implements the descriptor generator, assignment component, matrix generator, factorization component and output component.

In accordance with another aspect of the exemplary embodiment, a method for inferring user activity statistics from print job logs includes receiving job logs. Each job log includes print job information for a print job performed for a respective one of a plurality of users by a respective one of a plurality of image rendering devices. A feature-based job descriptor is generated for each print job based on the respective job log. The feature-based job descriptor includes a feature for a ranking each of a plurality of image rendering devices including the image rendering device performing the print job. The ranking of the image rendering devices is based on historical usage of the image rendering device by the user. Each print job is assigned to one of a set of defined job types based on the feature-based job descriptor. A user activity matrix in which each row of the user activity matrix corresponds to a respective user-time period and each column corresponds to a respective one of the job types is composed. Each index of the matrix is based on a count of print jobs assigned to a respective one of the job types for the respective user in the respective time period. The user activity matrix is decomposed into first and second factor matrices. A first of the factor matrices includes, for each job type, a set of non-negative factors. The second factor matrix includes, for each user-time period a set of non-negative factors. User activity statistics are output based on at least one of the second factor matrix and reconstruction errors between the user activity matrix and a reconstructed matrix that is the product of the first and second factor matrices.

At least one of the generating, assigning, composing, decomposing, and outputting may be performed with a processor.

### BRIEF DESCRIPTION OF THE DRAWINGS

FIG. 1 is a functional block diagram of a print infrastructure including a system for inferring user activity statistics from the job logs of the print infrastructure in accordance with one aspect of the exemplary embodiment;

FIG. 2 is a flow chart illustrating a method system for inferring user activity statistics from the job logs of a print infrastructure;

FIG. 3 is a block diagram of illustrative components of the system of FIG. 1 and data which is generated;

FIG. 4 illustrates decomposition of a job type count matrix for a set of users into factor matrices;

FIG. 5 is a plot of number of jobs vs job type rank for a print infrastructure;

FIG. 6 is a plot of number of workdays vs reconstruction error illustrating outliers;

FIG. 7 graphically illustrates print jobs performed on different days for a set of users; and

FIGS. 8-11 are plots showing distributions of job types for different users.

### DETAILED DESCRIPTION

Aspects of the exemplary embodiment relate to a system and method for inferring user activity statistics from job logs of a print infrastructure.

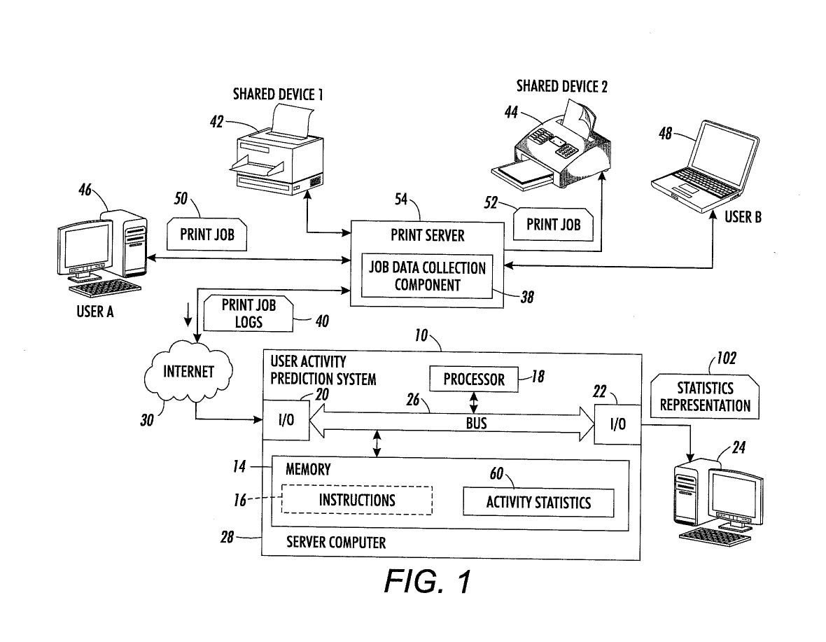

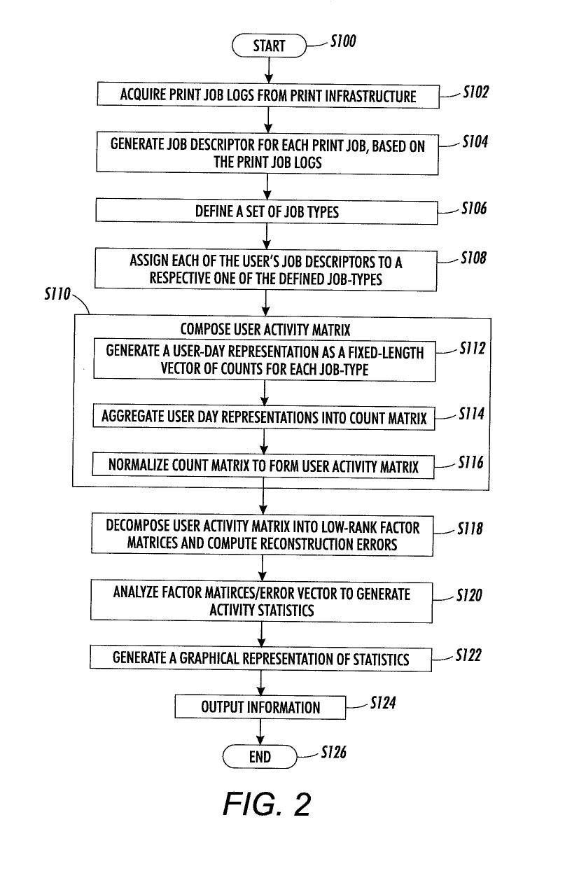

With reference to FIG. 1, a functional block diagram of a computer-implemented system 10 for inferring user activity statistics from job logs of a device infrastructure 12, such as a print infrastructure, is shown. The illustrated computer system 10 includes memory 14 which stores software instructions 16 for performing the method illustrated in FIG. 2 and a processor 18 in communication with the memory for executing the instructions. The system 10 also includes one or more input/output (I/O) devices, such as a network interface 20 and a user input output interface 22, for communicating with external devices. The I/O interface 22 may communicate with an output device, such as a display device 24, for displaying information to users. The various hardware components 14, 18, 20, 22 of the system 10 may all be connected by a data/control bus 26.

The computer system 10 may include one or more computing devices 28, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 14 may represent any type of non-transitory computer readable medium such as random access memory (RAM), read only memory (ROM), magnetic disk or tape, optical disk, flash memory, or holographic memory. In one embodiment, the memory 14 comprises a combination of random access memory and read only memory. In some embodiments, the processor 18 and memory 14 may be combined in a single chip. Memory 14 stores instructions for performing the exemplary method as well as the processed data.

The network interface 20 allows the computer to communicate with other devices via a computer network 30, such as a local area network (LAN) or wide area network (WAN), or the Internet, and may comprise a modulator/demodulator (MODEM) a router, a cable, and/or Ethernet port.

The digital processor device 18 can be variously embodied, such as by a single-core processor, a dual-core processor (or more generally by a multiple-core processor), a digital processor and cooperating math coprocessor, a digital controller, or the like. The digital processor 18, in addition to executing instructions 16 may also control the operation of the computer 28.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The device infrastructure 12 includes a job data collection component 38 which acquires job logs 40 for a set of shared devices 42, 44. The shared devices 42, 44 are in communication with client devices 46, 48. The client devices 46, 48 are operated by respective users, denoted User A and User B, each identifiable by a respective user identifier (user ID). The illustrated shared devices 46, 48 are image forming devices which execute print jobs 50, 52. The illustrated job data collection component 38 may be a part of or in communication with a print server 54 which receives the print jobs 50, 52 and directs them to the appropriate printers for printing. In other embodiments, the job data collection component 38 is communicatively connected with one or more of the image forming devices 42, 44 and/or one or more of the client computing devices 46, 48 for acquiring the job logs therefrom. At least some of the users each have access to at least two of the image forming devices 42, 44 and use each of the at least two of the image forming devices for executing print jobs over an extended time period. Different users may use different combinations of printers in the extended time period, for example based on the locations of their client devices 46, and/or the type of jobs that they print in performing tasks assigned to them. As will be appreciated, the print infrastructure 12 may include any number of image forming devices and client computing devices. Jobs, such as print jobs 50, 52, etc., generated at the client devices 46, 48 are each sent to a selected one of the image forming devices 42, 44 for printing either directly, or via the print server 54, if present. The job data collection component 38 may be hosted by the print server 54 or otherwise communicatively connected with the print infrastructure 12 for acquiring print job logs 40 or for acquiring raw data from which the print job logs are generated.

As used herein, an image forming device 42, 44 can include any device for rendering an image on print media, such as a copier, printer (e.g., laser or inkjet), bookmaking machine, facsimile machine, or a multifunction machine (which includes one or more functions such as scanning, archiving, emailing, and faxing in addition to printing). “Print media” can be a usually flimsy physical sheet of paper, plastic, or other suitable physical print media substrate for images.

A “print job” 50, 52 is normally a set of related sheets, usually one or more collated copy sets copied from a set of original print job sheets or electronic document page images, from a particular user, or otherwise related. An image generally may include information in electronic form which is to be rendered on the print media by the image forming device and may include text, graphics, pictures, and the like. The operation of applying images to print media, for example, graphics, text, photographs, etc., is generally referred to herein as printing or marking.

The job data collection component 38 outputs the print job logs 40, giving, for each job 50, 52, information such as some or all of: submission date and time, an ID of the image forming device 42, 44 executing the print job, user ID, document title, page count, page size (A4, A5, custom, etc.), and various indicators, e.g., whether the job is in color, in duplex mode, etc. This information is usually readily available at a customer site, as it is generally collected by the print server. Some or all of the print job content (e.g., text and/or images, such as a raster image that is sent to the printer to be printed), or a representation thereof (e.g., a histogram of word counts in the case of a text document) may also be made available as part of the job logs.

The user activity prediction system 10 acquires the print job logs 40 from the print infrastructure 12 over the course of several days or weeks and processes the job logs to generate user activity statistics 60 for a set of users A, B, etc. Eᵢ

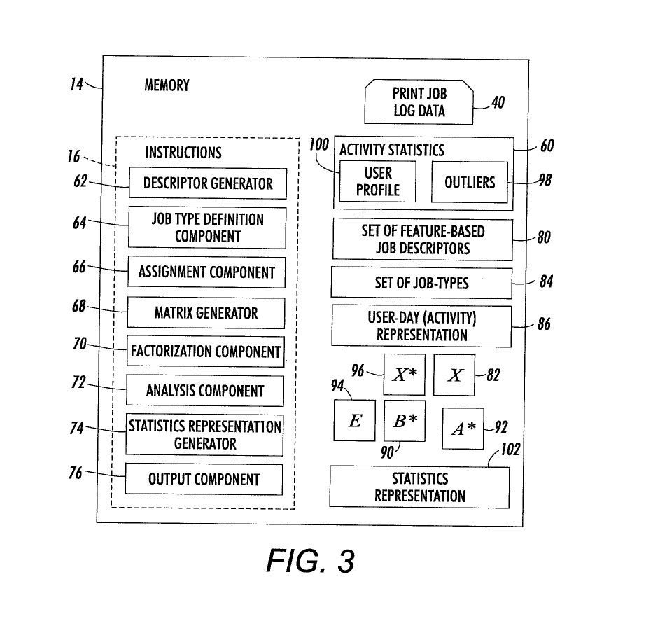

With reference also to FIG. 3, which shows the system memory 14 in greater detail, the instructions 16 may include a descriptor generator 62, a job type definition component 64, an assignment component 66, a matrix generator 68, a matrix factorization component 70, an analysis component 72, a statistics representation generator 74, and an output component 76. Briefly, the descriptor generator 62 generates a job descriptor 80 for each print job from the information stored in the job logs 40, e.g., as a multidimensional feature vector. The matrix generator 68 generates a user activity matrix 82, denoted X, based on the job descriptors 80, which represents counts of discrete job types for each of a set of predefined time periods (e.g., days) for each user. The job type definition component 64 represents the job types by multidimensional vectors 84 such that each of the job types corresponds to a respective, unique combination of discrete features. The assignment component 66 assigns the job descriptors 80 to the appropriate job type. These assignments are used to generate, for each user and for each of a set of days, a user-day (activity) representation 86 from which the user activity matrix 82 is assembled. The factorization component 70 decomposes the user activity matrix 82 into a job type factor matrix 90 and a user-day factor matrix 92, denoted B* and A*. The decomposition may be performed using non-negative matrix factorization, to minimize an overall reconstruction error 94 between matrix 82 and a reconstructed matrix X* 96 that is regenerated from the factor matrices B* and A*. The overall reconstruction error takes into account a difference between each cell of matrix X and the corresponding cell of matrix X*. The analysis component 72 analyzes one or more of the factor matrices 90, 92, and/or error matrix 96 to produce the activity statistics 60. This may include extracting an error vector Eᵢ 97 which represents reconstruction errors for a given user, from which outliers 98 can be detected. In another embodiment, analysis component 72 extracts user profiles 100 from the factor matrix 92 and may compare them. The statistics representation generator 74 may generate a representation 102 of the statistics 60 for visualization on the output device 24. The output component 76 outputs information based on the analysis, such as the (graphical) statistics representation 102.

FIG. 2 illustrates a method of inferring user activity statistics from the job logs of a print infrastructure, which may be performed with the system of FIGS. 1 and 2. The method begins at S100.

At S102, print job logs 40 are acquired from a print infrastructure 12 for a set of at least one or a plurality of users (such as at least 5 or at least 10 users) for a plurality of days (such as at least 5 or at least 10 days) and may be stored in memory 14.

At S104, a job descriptor 80 is generated for each print job, by the descriptor generator 70, based on the print job logs, each job descriptor comprising a set of features for a respective job.

At S106, a set 84 of job types is defined. Each job type is represented by a respective fixed length vector of discretized features.

At S108, for each user-day, each of the user's job descriptors is assigned to a respective one of the job types.

At S110, a (normalized) user activity matrix 82 is composed by the matrix generator 72, which represents the count of each of a set of n job types for each of a set of m user-time periods, such as days. for each user-day, generating a user-day representation 86 for the user as a vector of counts of the job descriptors assigned to each job type (S112); aggregating the user-day representations for the set of m user-days into a count matrix (S114), and normalizing the count matrix to generate user activity matrix 82 X (S116). In the resulting user activity matrix 82, the activity of each user for each of a plurality of days is represented as a vector of the job types, each index of the vector being based on a count of a respective one of the job types for that day (or other selected time period).

At S118, the user activity matrix X is decomposed by the factorization component 70, e.g., using non-negative matrix factorization, to generate non-negative factor matrices B* and A*.

At S122, one or more of: the factor matrices B*, A*, and an error vector E of one or more users is analyzed, by the analysis component 72, to generate activity statistics 60.

At S124, a (graphical) representation 102 of the activity statistics 60 may be generated by the statistics representation generator 74.

At S126, information is output, which is based on the analysis, such as the graphical representation 102, information on outliers 98 (which may include generating an alert for a detected outlier), a user profile 100 (a linear combination of the prototypes from matrix A*), or results of a comparison of two or more user profiles or two or more error vectors, or part of the matrix X. The information may be used by the customer to modify print behavior, for example, by identifying users who print more copies than other users with similar job functions and encouraging them to print less, or to follow up with users as to the reasons for outlier days.

The method ends at S128.

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 28, (for example, an internal hard drive of RAM), or may be separate (for example, an external hard drive operatively connected with the computer 28), or may be separate and accessed via a digital data network such as a local area network (LAN) or the Internet (for example, as a redundant array of inexpensive of independent disks (RAID) or other network server storage that is indirectly accessed by the computer 28, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 2, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

Further details on the system and method will now be provided.

In the following, the terms “optimization,” “minimization,” and similar phraseology are to be broadly construed as one of ordinary skill in the art would understand these terms. For example, these terms are not to be construed as being limited to the absolute global optimum value, absolute global minimum, and so forth. For example, minimization of a function may employ an iterative minimization algorithm that terminates at a stopping criterion before an absolute minimum is reached. It is also contemplated for the optimum or minimum value to be a local optimum or local minimum value.

### Job Descriptors (S104)

Since the focus is on representing user activity, the job descriptors 80 ideally contain information that is relevant to the user activity and thus information can be represented generically. For example, the identity of the specific device 42, 44 used for a print job depends mainly on the context of the user rather than his or her activity. The device ID of a job can thus be converted to a device rank, the rank being based on the user's historical printer usage, which may be defined as the rank of that device in the set of devices 42, 44 associated with all the jobs by the same user in a given extended time period (e.g., a week). Thus, a device rank of 1 denotes the device most used by the user of the job during the week in which the job was performed, a device rank of 2 denotes the second most used device that week, etc. If a print job is executed by the device with rank 2, the job descriptor for the job may thus include a 2 for the feature corresponding to the printer rank. Alternatively, the rank can be replaced by the proportion. Other features can also be transformed in the same way. For example, the document type, e.g., text (Word), drawing (PowerPoint), PDF, etc. may be inferred from the document title and incorporated into respective features of the job descriptor.

Thus for example, a set of about 10-20 features could be used for the job descriptor 80, for example a job descriptor could include the features (date and time, printer (e.g., as a rank), document type (e.g., as a rank), number of pages, color or monochrome, single or double sided, paper size, paper type (e.g., regular or bond), etc.).

Mapping the Data into a User Activity Matrix

The target of the analysis is the activity of a user over a fixed time period, such as a day. Hence, the job descriptor 80 data is split by (user ID, date) pairs, referred to herein as user-days. Each user-day is a bag (unordered set) of print jobs generated by one user over one day, each print job being described by a fixed-length vector 80 of features. This variable-size set of job descriptors 80 is transformed into a user-day representation 86, for a given user and day, which is a fixed-length vector.

One way to achieve this is by discretizing the job features, so that the transformed job space becomes discrete (S106). In this approach, each job type 84 in a set of job types is first defined as a combination of (discrete) job feature values. Different methods of discretization may be employed. The following is an illustrative job type:
device-rank=1, type-rank=2, pagecount-range=3, time-range=2, color=1, duplex=0

A job of that job type is printed on the most used printer of the user during that week, its document is of the second most used type, it contains 10 to 50 pages (“3” is the identifier of the 10-50 page count range), it was printed between 9 am and 12 pm (“2” is the identifier of that hour range), etc. As will be appreciated, the finer grained the individual features, the greater the number of job types, and too many job types may be unwieldy. In theory, the number of job types is the product of the size of each discretized feature range. However, in practice, the number of job types is much lower, as many combinations are often not present in the data. Additionally, very rare job types, whose number of occurrences in the job descriptors is below a threshold, can be discarded. In some cases, the rare job types can be used for outlier detection at the job level. In some embodiments, highly frequent job types (analogous to stop-words in the document realm) can also be discarded. User-days where no printing is performed can be ignored. The number of unique job types remaining after optionally discarding some (e.g., the low and/or high frequency ones) is not limited and may be, for example, at least 50, or at least 100, or at least 500, or at least 1000, and may be up to 10,000, or more.

Each user-day can then be converted to a bag (unordered set) of job types where the job types 84 take their values in a finite set (S108). This includes, for each user day, assigning each of the job descriptors for that user to a corresponding one of the job types whose discretized features match the features of the job descriptor. The features of each job descriptor are already converted to the corresponding discretized features with which the job types are defined. The discretized job descriptor can thus be assigned to a job type with the same vector of discretized features. In composing the user activity matrix (S110), a user-day vectorial representation 86 of the bag of job types is generated at S112 for a user for one day. This can simply be a vector of counts of the different job types. The data for a set of user-days for at least one user (generally, user-days for a set of users and days) is then represented by a count matrix (S114), the m rows of which are the user-days and the n columns of which are the job types. The cell at row i and column j is the count of jobs of job type j during the user-day i. Thus, for each time period, such as a given day, there may be two or more user-days, each for a respective user, such as five, ten, or more, depending on the number of users of the print infrastructure printing on that day. Similarly, for a given user, there may be two or more user days, each for a respective day, such as five, ten, twenty or more user-days, depending on the numbers of days-worth of data acquired. The count matrix can be normalized (S116) so that in the resulting user activity matrix 82 each user-day is represented by a vector of proportions (rather than counts) of the different job types. There are other methods, analogous to the “tf-idf” method in the document realm, which may alternatively be used, where each count (the “tf” part) is multiplied by a weight which depends on the frequency of the job-type in the whole dataset (so that very frequent job-types are given less weight when they appear in a user-day). See, for example, Christopher D. Manning, et al., Eds., “Introduction to Information Retrieval,” Ch. 6, “Scoring, term weighting and the vector space model,” in pp. 109-133, Cambridge University Press 2008, which can be adapted to the present method.

Another method for defining job types and achieving fixed length user-day representations 86 is by deriving a Fisher vector corresponding to each job descriptor from a generative model of the job descriptor data (e.g., using a naive Bayes model or a Gaussian Mixture Model). The Fisher vector can then be assigned to a nearest one of a set of clusters of the Fisher vectors, each cluster corresponding to a job type. A description of the computation of Fisher vectors is given in Jorge Sanchez, et al., “Image Classification with the Fisher Vector: Theory and Practice, Intl J. Computer Vision Vol. 105, Issue 3, pp. 222-245 (2013) and in U.S. Pub. No. 20120076401, published Mar. 29, 2012, entitled IMAGE CLASSIFICATION EMPLOYING IMAGE VECTORS COMPRESSED USING VECTOR QUANTIZATION, by Jorge Sanchez, et al., and U.S. Pub. No. 20120045134, published Feb. 23, 2012, entitled LARGE SCALE IMAGE CLASSIFICATION, by Florent Perronnin, et al., the disclosures of which are incorporated herein by reference in their entireties.

An advantage of the method using job types defined in terms of discretized features, however, is not only simplicity but also interpretability, since the components of a Fisher vector are not straightforward to interpret.

### Matrix Factorization (S118)

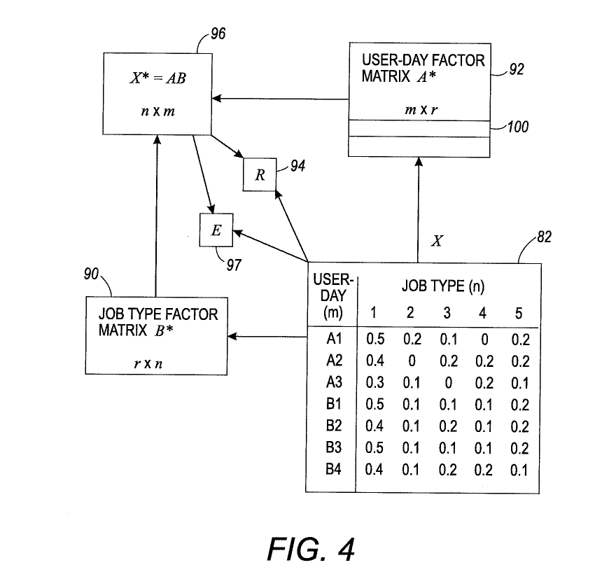

The matrix factorization component 70 performs matrix factorization on the normalized user activity matrix 82, denoted X, as graphically illustrated in FIG. 4. As noted above, each user-day is represented in the matrix 82 as a vector of proportions of the different job types. The factorization results in a representation of each user-day vector as a linear combination of vectors from a fixed set of hidden prototypes (also known as basis vectors). The vector of coefficients (also known as factors) of the combination of basis vectors is called the embedding of that user-day. Given the data matrix X of size m×n (where m is the number of user-days and n the number of job types) and a choice of low rank r (number of basis vectors, which satisfies r<<min(m,n)), the matrix factorization component computes a first, job type factor matrix 90, denoted B* of size r×n and a second, user-day embedding matrix 92, denoted A* of size m×r in such a way as to minimize the overall reconstruction error R 94 which characterizes how the data matrix X differs from its factorization. This can be represented by the following optimization problem to minimize the reconstruction error:

$${A}^{*} , {B}^{*} = arg { min}_{A \geq 0 , B \geq 0} {‖ X - AB ‖}_{F} \qquad ( 1 )$$

where A* denotes the optimal non-negative matrix A and B* denotes the optimal non-negative matrix B. Matrix X* is the reconstructed version of matrix X and is the product of (optimal) matrices A and B. The constraint B≧0 means that each prototype itself represents a vector of proportions of job types. To achieve that, each row of B may be constrained to sum to 1, but that is unnecessary since any solution to (1) can straightforwardly be converted into another solution satisfying that property. The constraint A≧0 means that each prototype can contribute to explain the presence of a combination of job types for a given user-day (or not if the coefficient is null), but never an absence thereof. The ∥•∥_{F} operator denotes the “Frobenius” norm on matrices, defined as the usual norm of the vector obtained by flattening the matrix (concatenating its cells, in any order). However, other norms may alternatively be used as a measure of the reconstruction error. Minimizing the reconstruction error ∥X−AB∥_{F} makes X as close as possible to its factorization AB. Ideally, if the reconstruction error were null, it would mean that all the user-days (cardinality m, a large number) can be exactly reconstructed as linear combinations of the prototypes (cardinality r, a small number).

r can be selected based on the type of analysis sought. For example, when the analysis being performed entails identification of outlier user-days, a value of r of from 10-20 may be appropriate, e.g., when the minimum of m and n is at least 500. However, different values of r, such as at least 5, or at least 10, or at least 20, or up to 100, may be more suitable in other contexts, and may be identified experimentally. It may be noted that increasing the value of r reduces the reconstruction error and thus the proportion of outliers is decreased. Similarly if r is too small, too many user-days may be flagged as outliers. Thus, for some embodiments, having too high or too low a value of r may not be useful.

A solution to Eqn. (1) can be achieved using Non-negative Matrix Factorization (NMF). A number of efficient implementations are available, a common one being alternating least squares with projected gradient, which alternates optimization of matrix B with matrix A fixed and optimization of matrix A with B fixed for a number of iterations and/or until convergence is reached. See, for example, Chih-jen Lin, “Projected gradient methods for Nonnegative Matrix Factorization,” Neural Computation, 19 (10), pp. 2756-2779, 2007. This approach is adopted in the Scikit-learn package used in the Examples below. Other methods are described in M. Chu, et al., “Optimality, computation and interpretation of nonnegative matrix factorizations,” SIAM J. Matrix Anal 4-8030 (2004), available at http://www.wfu.edu/-plemmons/papers/chu_ple.pdf. See, also C. O. S. Sorzano, et al., “A survey of dimensionality reduction techniques,” (2014), available at http://arxiv.org/abs/1403.2877, for other dimensionality reduction techniques which may be used to generate the factor matrices.

### Analysis (S120)

The matrix factorization (S118) yields valuable synthetic information about the activities of the users and can be used to generate various activity statistics. The following are examples:

1. The rows of matrix A* represent prototypical user-days. Their job type distributions can be displayed and analyzed. The users can be ranked over the whole data or over a subset of user-days, e.g., by summing (a subset of) the rows of embedding matrix A*. A comparison of the ranking for one specific user with that of a group of similar users can be made, e.g. those working in the same department, or having a similar function.

2. The rows 100 of embedding matrix A* give a synthetic description of the activity of one user over a day and can be considered as a representative user profile for that day. By taking the sequence of these user profiles 100 of a given user ordered by date, an analysis of the evolution of the user's printing behavior can be made.

3. Reconstruction errors 97 in the matrix factorization are informative. Let E be the vector of size m with an entry defined for each user-day i defined by Eᵢ=∥(X−A*B*)_{i.}∥. This is the specific reconstruction error of user-day i. Note that the norm ∥E∥ is exactly the Frobenius norm ∥X−A*B*∥_{F} 94 which the matrix factorization minimizes, so the components of E are, by construction, close to 0. However, the discrepancies among them are informative: the highest components of E, in absolute value, characterize the user-days which are hardest to reconstruct in terms of the prototypes, hence can be identified as outliers 98.

The information generated may include raising a flag when an outlier 98 is detected (e.g., when the reconstruction error exceeds a threshold value) or when a user's profile varies over the course of two or more user days. If labeled training data is available for training a classifier, a flag may be raised when a user's day profile or error vector is classified as being an exception. If the user changes from printing on the printer ranked 1 to the printer ranked 2, this may be an indicator that the printer is malfunctioning or that the user's activity has changes, which may trigger a flag for investigation. Protocols may be put in place for detecting potential fraud, waste, or abuse based on specified changes in the user's activity profiles 100.

Without intending to limit the scope of the exemplary embodiment, the following examples illustrate the application of the method to print job logs.

### Examples

The dataset used for the examples includes 1,927,329 jobs by 1,686 users spread over the course of a year. Jobs are described by 10 raw descriptors and content is not available. After cleaning and pre-processing (feature construction), 675,295 jobs each with 16 descriptors, by 429 users remained. Finally, the activity matrix X has m=33,654 rows (user-days) and n=1,563 columns (job types) with 282,243 non-zero cells (density: 5.3 non-zero cells per thousand (‰)). The matrix factorization was computed with r=15 protoypes. All the experiments were performed using the Scikit-Learn toolkit for Python http://scikit-learn.org/stable/. A toolkit for matrix decomposition, Scikit learn, was used, which is available at https://github.com/scikit-learn/scikit-learn/blob/master/sklearn/decomposition/nmf.py, was used for matrix decomposition by non-negative matrix factorization. PCA implementations used http://scikit-learn.org/stable/modules/decomposition.html#pca.

Since the data was not labeled, no quantitative analysis could be performed. However, the analysis was able to generate useful information, such as outlier days and user profiles, which could be provided to customers to assist them in monitoring and changing print behavior. Various visualizations of the results of the analysis show different aspects of the information, however these could be tailored to the customer's needs and to render them more intuitive.

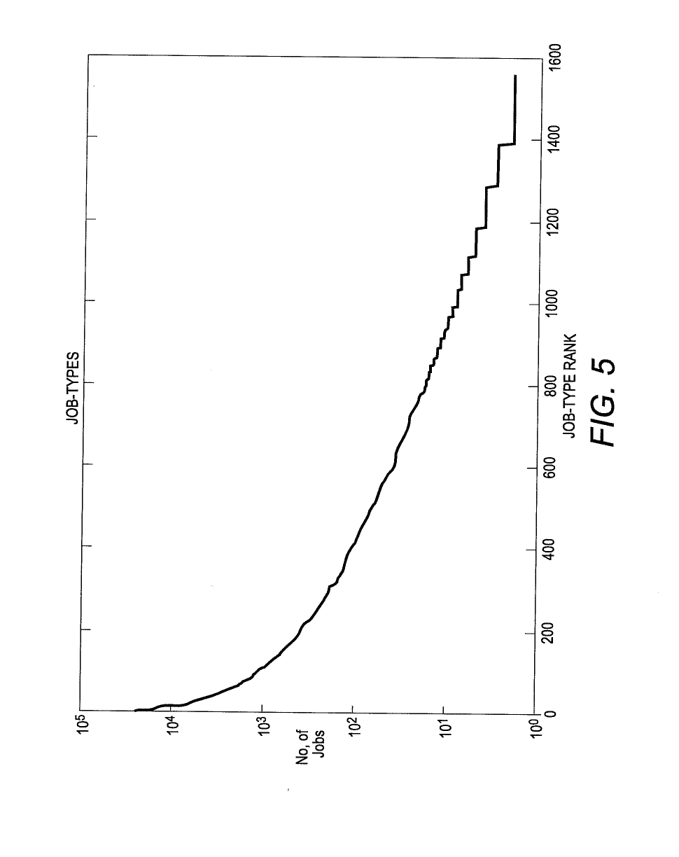

FIG. 5 shows the frequency of job types in decreasing order on a logarithmic scale. This shows the extreme variability in frequency of the job types. Note that in this representation, job types occurring only once in the data are discarded, but all the high frequency ones are kept.

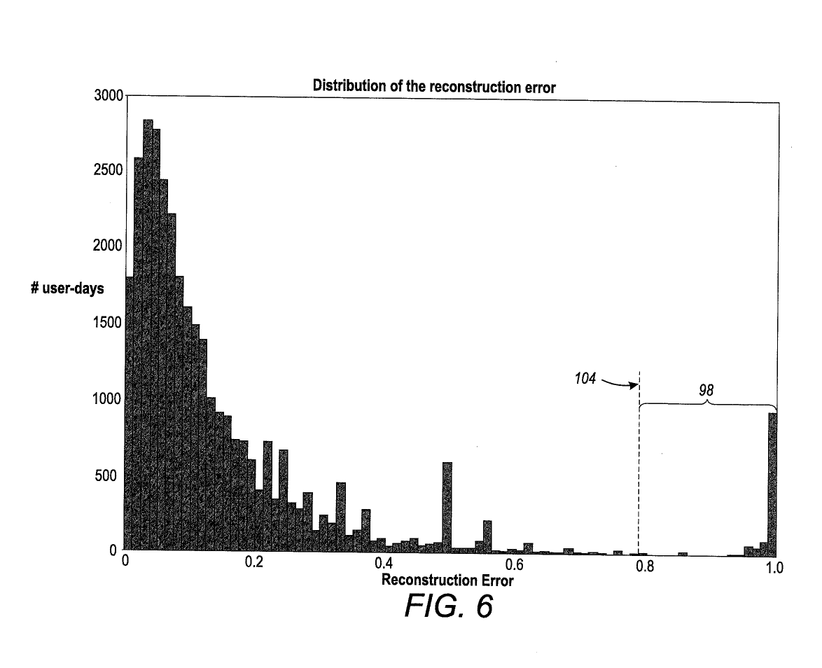

FIG. 6 shows the distribution of the reconstruction error of the individual user-days. As expected, the majority is skewed towards small values (since the objective of the factorization is to keep reconstruction errors low), however, there is a spike towards the highest value. These are mainly user-days where all the jobs are of a single job type, and a sufficiently rare one that is not reflected in the prototypes. They typically qualify as outliers 98. A threshold 104 may be implemented for identifying the outliers (those that meet or exceed the threshold), such as at about 0.8 or 0.6, or 0.5, depending on the customer's needs.

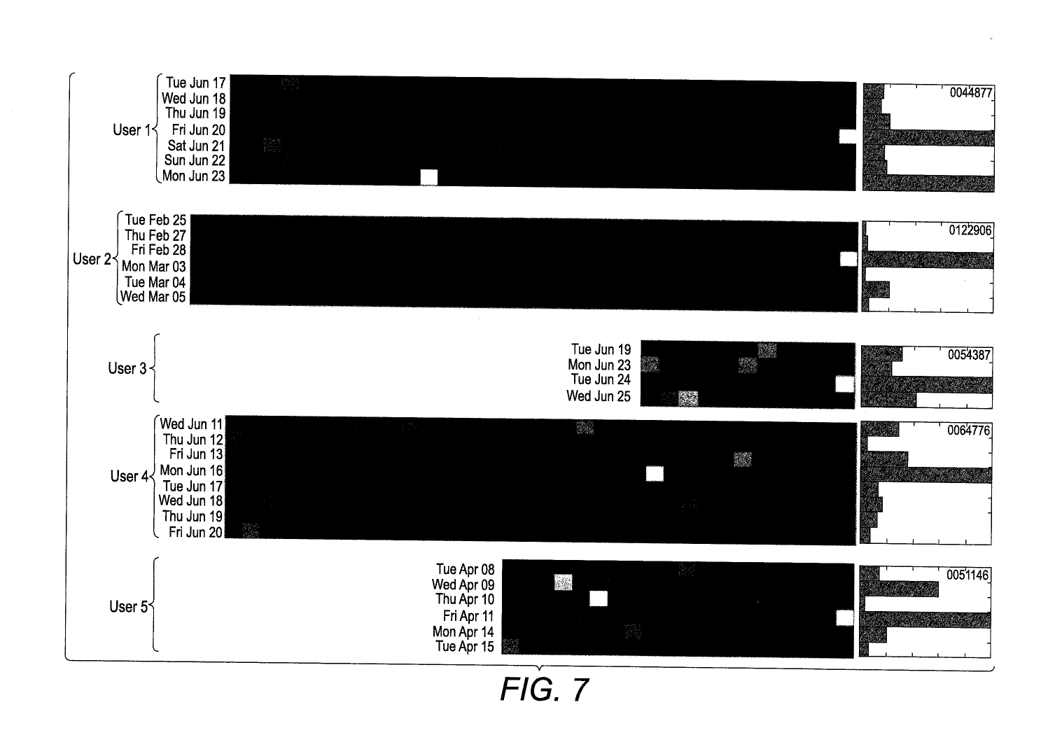

FIG. 7 shows details of five user-days having a high reconstruction error (User 1, Friday June 20; User 2, Friday February 28; User 3, Tuesday June 24; User 4, Monday June 16; User 5, Friday April 11). Each selected user-day is displayed in the context of all the user-days by the same user within the 5 days before and after (The exact number of user-days in that 10-day context is variable because user-days with no activity, typically (but not only) week-ends, are not represented). The horizontal bar-plots on the right give the level of the reconstruction error for all the user-days of the same user. The grayscale-map plots on the left show the actual distribution of job types for each user-day of the same user: the job type proportions are color coded on a grayscale (black for 0 and white for 1). Each row represents a user-day (date on the left) and each column corresponds to a job type occurring in at least one of the user-days displayed for the same user (i.e., not all the job types are displayed, only the ones used by the user). Thus, the plots are direct excerpts of the full data matrix X. In an interactive visualisation, the exact definition of the selected job types (combination of feature values which define them) can be displayed in a status bar by hovering with the mouse on any of the columns.

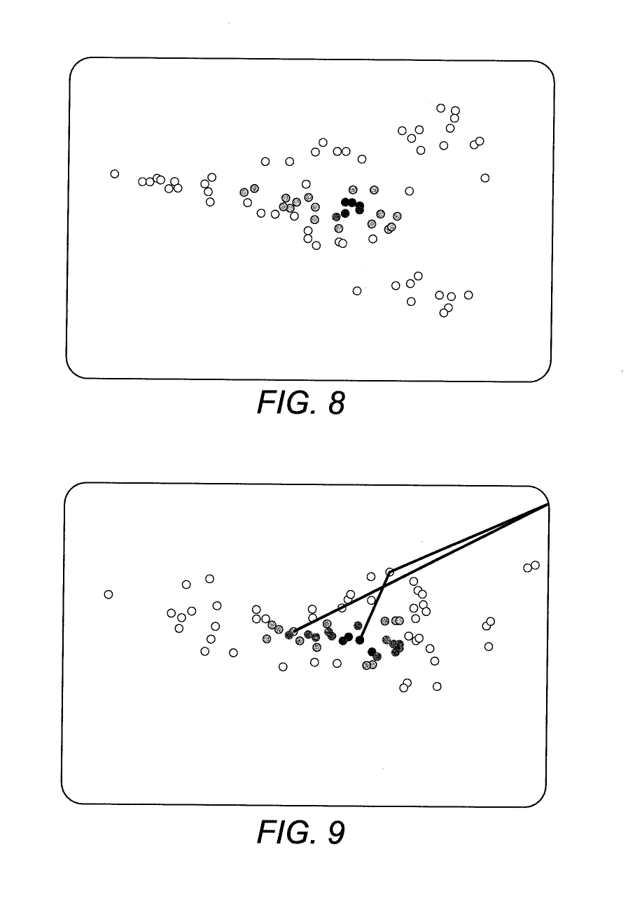

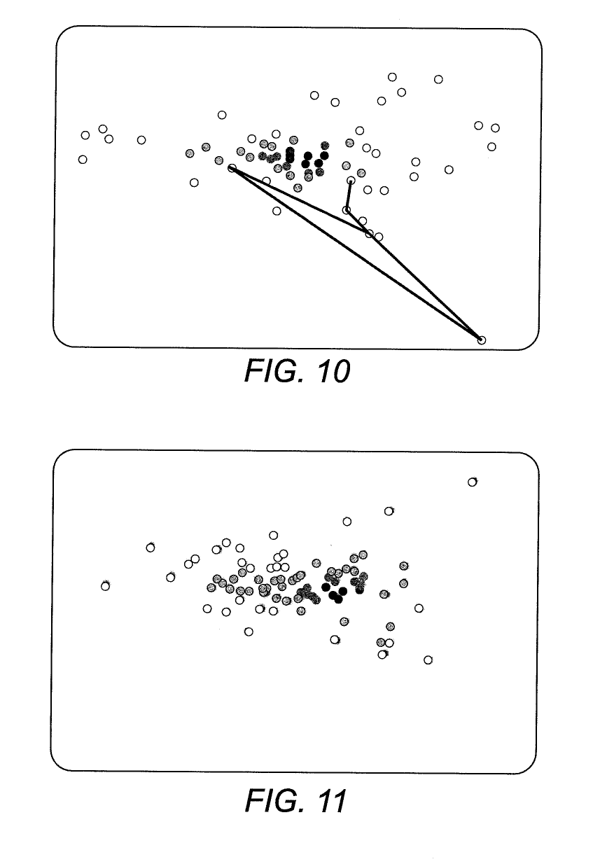

FIGS. 8-11 are 2D representations of user-days of four different users. Each point represents one user-day through the projection of its embedding in a 2D space using a singular value decomposition (SVD)-based dimensionality reduction technique. The color (or other attribute, such as size or shape), of a point represents the density (densities are estimated by a standard Gaussian kernel density estimation technique) of the cloud of projections of all the user-days at that point. For illustrative purposes, greyscale is used to denote density, thus a light gray point is a relatively isolated user-day while an almost black point is in a dense area. Furthermore, some short segments of the trajectory of each user (sequence of consecutive user-days for the same user) are also represented. In an interactive visualization, the segment can be chosen by clicking on a point (user-day), which then displays the previous two and next two points in the trajectory. The date of the selected point (center of the segment) appears in the bottom-left corner.

PCA (as described in section 2.2 of Sorzano 2014) is applied in the non-negative matrix factorization, clipped at the first 2 eigenvalues to the result of the NMF (the embeddings) to provide the trajectory representation in the plane. Another NMF with rank directly set to 2 would have given the same result.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for inferring user activity statistics from job logs of a device infrastructure comprising:
receiving job logs of a device infrastructure, each job log including job information for a job performed for a respective one of a set of users by a respective one of a plurality of shared devices;
generating a feature-based job descriptor for each job based on the respective job log;
assigning each job to one of a set of defined job types based on the feature-based job descriptor;
composing a user activity matrix in which activity of each user of the device infrastructure, for each of a plurality of time periods, is represented as a fixed-length vector representing at least some of the job types, each index of the vector being based on a count of a respective one of the assigned job types for the respective user in the respective time period;
decomposing the user activity matrix into first and second factor matrices to minimize an overall reconstruction error between the user activity matrix and a reconstructed matrix generated from the factor matrices;
for one of the users, generating a vector of specific reconstruction errors, each of the specific reconstruction errors being computed between the user activity matrix and the reconstructed matrix, for a respective one of the time periods, for that user and identifying, based on the vector, time periods that constitute outliers; and
raising a flag when an outlier is detected;
wherein at least one of the generating, assigning, composing, decomposing, and outputting is performed with a processor.

2. The method of claim 1, wherein each of the set of job types is represented by a fixed length vector of features.

3. The method of claim 2, wherein each of the job types corresponds to a unique combination of discrete features and wherein the assigning each of the jobs to a respective one of the job types comprises assigning the job to the job type with discrete features that match the feature-based job descriptor.

4. The method of claim 1, wherein the job types are each defined by a vector of discretized features.

5. The method of claim 1, wherein the composing of the user activity matrix includes:
for each of the users, for each of a plurality of time periods, generating a representation of activity of the user for the respective time period as a vector of counts of the feature-based job descriptors assigned to each job type; and
optionally, normalizing the activity representations; and
aggregating the activity representations into the user activity matrix.

6. The method of claim 1, wherein the first factor matrix comprises, for each job type, a vector of factors and the second factor matrix comprises, for each of a set of user time periods, a vector of factors.

7. The method of claim 1, wherein the outputting user activity statistics comprises outputting a visualization of at least a part of the user activity statistics.

8. The method of claim 1, wherein the output user activity statistics includes information which is based on reconstruction errors between the user activity matrix and the reconstructed matrix and identifies, as outliers, time periods in which the reconstruction error for a given user exceeds a threshold.

9. The method of claim 1, wherein the output user activity statistics includes information which is based on the second factor matrix and includes at least one of:
a ranking of at least one user, the ranking being based on a vector of factors for the user and vectors of factors for some of the other users, for at least one of the time periods;
a ranking of at least one user, the ranking being based on an aggregation of vectors of factors for the user for a set of time periods and aggregated vectors of factors for some of the other users, for the set of time periods; and
an analysis of evolution of a user's activity based on a sequence of vectors of factors for the user ordered by date.

10. The method of claim 1, wherein each of the factor matrices includes a same number of factors.

11. The method of claim 1, wherein the output information is based on user profiles for a user, each of the user profiles being derived from a row of the second factor matrix which is representative of user activity in a respective day.

12. The method of claim 1, wherein the decomposing of the user activity matrix into first and second factor matrices is performed by non-negative matrix factorization.

13. The method of claim 1, wherein the jobs comprise print jobs and the shared devices comprise image rendering devices.

14. The method of claim 13, wherein the feature-based representation of each job includes features selected from:
print job submission date and time;
a rank of the image forming device executing the print job, the rank being based on the user's historical printer usage;
a rank of the document type;
an identifier of the user;
a document title;
a page count;
a page size;
an indicator of whether printing is at least one of: color or monochrome, single or double sided, and paper type;
content of the print job or a representation thereof;
and combinations thereof.

15. The method of claim 1, wherein each of the time periods is a single day.

16. A computer program product comprising a non-transitory recording medium storing instructions, which when executed on a computer, causes the computer to perform the method of claim 1.

17. A system comprising memory which stores instructions for performing the method of claim 1 and a processor in communication with the memory for executing the instructions.

18. In combination, a device infrastructure and a system for inferring user activity statistics from job logs of the device infrastructure, the device infrastructure comprising:
a plurality of shared devices, each of the shared devices generating job logs;
the system comprising:
a job data collection component which acquires a set of the job logs from the shared devices, each job log including job information for a job performed for a respective one of a plurality of users by a respective one of the plurality of shared devices;
a descriptor generator which generates a feature-based job descriptor for each of the set of job logs;
an assignment component which assigns each job to one of a set of defined job types based on the respective feature-based job descriptor;
a matrix generator which composes a user activity matrix in which activity of each user for each of a plurality of time periods is represented as a fixed-length vector representing at least some of the job types, each index of the vector being based on a count of a respective one of the assigned job types in the respective time period;
a factorization component which decomposes the user activity matrix into first and second factor matrices, the factorization minimizing an overall reconstruction error between the user activity matrix and a reconstructed matrix generated as the product of the factor matrices;
an output component which outputs user activity statistics based on at least one of:
the first factor matrix,
the second factor matrix, and
reconstruction errors between the user activity matrix and the reconstructed matrix; and
a processor which implements the job data collection component, descriptor generator, assignment component, matrix generator, factorization component and output component.

19. The system of claim 18, further comprising a job type definition component which defines each job type as a fixed-length vector of features.

20. A method for inferring user activity statistics from print job logs comprising:
receiving job logs, each job log including print job information for a print job performed for a respective one of a plurality of users by a respective one of a plurality of image rendering devices;
generating a feature-based job descriptor for each print job based on the respective job log, wherein the feature-based job descriptor includes a feature for a ranking each of a plurality of image rendering devices including the image rendering device performing the print job, the ranking of the image rendering devices being based on historical usage of the image rendering device by the user;
assigning each print job to one of a set of defined job types based on the feature-based job descriptor;
composing a user activity matrix in which each row of the user activity matrix corresponds to a respective user-time period and each column corresponds to a respective one of the job types, each index of the matrix being based on a count of print jobs assigned to a respective one of the job types for the respective user in the respective time period;
decomposing the user activity matrix into first and second factor matrices, a first of the factor matrices comprising, for each job type, a set of non-negative factors, the second factor matrix comprising, for each user-time period a set of non-negative factors;
outputting user activity statistics based on at least one of:
the second factor matrix, and
reconstruction errors between the user activity matrix and a reconstructed matrix that is the product of the first and second factor matrices,
wherein at least one of the generating, assigning, composing, decomposing, and outputting is performed with a processor.
